(19) United States
(12) Patent Application Publication
(10) Pub. No.: US 2004/0172408 A1
(43) Pub. Date: Sep. 2, 2004

(54) Real time maintenance of a relational database priority

(76) Inventors: Jorg Klosterhalfen, Koln (DE); Heinz-Dieter Smets, Niederkruchten (DE)

Correspondence Address: EPSTEIN DRANGEL BAZERMAN & JAMES, LLP, 60 EAST 42ND STREET, SUITE 820, NEW YORK, NY, 10165, US

(21) Appl. No.: 10/738,415

(22) Filed: Dec. 17, 2003

(30) Foreign Application Priority Data
Feb. 27, 2003 (DE) 103 08 851.2

(51) Int. Cl. G06F 17/00

(52) U.S. Cl. 707/103 R

(57) ABSTRACT

The invention relates to a method for the real time maintenance of database content, in particular files (data sets), of a relational database, specifically DB2. Continuous availability with simultaneous continuous maintenance of a relational database is made available by a method in which the status of the database content is determined using a status monitor integrated in the database, in which status data of the determined status is output in real time using said database-integrated status monitor, in which said output status data is analyzed and compared to comparison data and in which maintenance functions are mostly activated directly following a positive compare result.

### PRIORITY

This application claims priority of pending German patent application number 103 08 851.2, filed on Feb. 27, 2003.

### FIELD OF THE INVENTION

The invention relates to a method for real time maintenance of database content, in particular of files (data sets) of a relational database, in particular IBM's DB2. The invention further relates to a device set up to conduct such a process a computer program for such a process, and a computer program product for such a process.

The invention relates to the area of relational databases, in particular DB2 from International Business Machines (IBM) on an OS/390 or z/OS operating system. In a relational database like IBM's DB2, data is managed in a multitude of indexes and tables. The data itself is represented physically by data sets and stored on a storage medium. The position, structure and size of the data sets is modified by read/write access during operation of the database. The database system accesses the data sets, which are changed in response to user input as well as due to internal work specifications. Due to these changes, the data sets require maintenance in order to realize better access times and better recovery times. The databases provide integrated maintenance functions (utilities) that can be used to conduct this type of maintenance work on the data sets.

### BACKGROUND OF THE INVENTION

Various utilities are important for maintenance, which include backing up data sets in order to recover data. This is necessary if data is corrupted or lost as a result of a malfunction of the machine, the operating system, or the database itself, or due to faulty programs or faulty user input. A necessary backing up of the data is made possible by a database utility.

Reorganization of the database is also important. During operation of the database, the database system relocates data within the data sets in response to internal processing controls in order to guarantee faster access to the data. Relocation of data occurs preferably in accordance with logical criteria so that data that belongs together is also physically stored together. However, after longer periods of operation, a good organization of the data is no longer guaranteed because of a multitude of relocation operations. Because of the multitude of relocation operations due to standard operation, a state of disorganization is created on the database that prevents fast access times to the data. In order to be able to guarantee fast access times to the data, the data must be reorganized once a certain degree of disorganization has been reached. The database provides a utility for this purpose, too.

The collection of statistics regarding the status of the data within the data sets is also an important task within databases. In the event of an application query for data, the database determines the optimum strategy to access the data using these statistics. The statistics provide insight into the internal workings of the database.

In DB2, the aforementioned utilities are COPY, REORG, and RUNSTATS. Other utilities are also available for maintaining data sets. In DB2, these include specifically the MODIFY and QUIESCE utilities.

To perform maintenance work, the utilities are activated using specific instructions. The instructions are stored in batch files (batch jobs). These batch files are coded in a so-called Job Control Language (JCL) and processed when the database is not used to capacity. The constant change in the number and content of the data sets results in the technical problem of dynamically creating real time maintenance instructions and adapting these to the respective existing data status.

In conventional relational databases, the status of the data sets is determined using external programs. Using this pre-determined status, the utilities necessary for maintenance are accordingly activated with the corresponding instructions. The disadvantage of monitoring the status using external programs is that external programs have a negative impact on system performance since these monitor programs require many system resources. These programs are also error-prone since they are oriented on the existing database and not integrated in it. When database functions and structures are changed, the external programs also have to be adapted.

It is the goal of database users to have databases available 24 hours a day 7 days a week. A 24/7 level of database availability in mainframes means constant good response times (for example, by real time reorganization and by real time statistics collection for constant optimization of data access), constant avoidance of errors (by real time reactions to critical situations), rapid recovery times in the event of faults (for example, by real time back up operations), as well as only minor interference of applications due to maintenance work. The prerequisite hereto, however, is that monitoring and maintaining of the database must take place virtually in real time. Due to intensive system usage by external monitor programs, these programs are unable to constantly monitor the database. Moreover, the periodic monitoring of the database by external programs, which is conducted nowadays in periods of many hours or days, results in a need for a multitude of maintenance work thereafter. After the monitoring runs, the instructions for the maintenance utilities are generated and stored in a file for batch processing. The file is then transferred to a job scheduler. The job scheduler is set such that it activates the utilities in certain time frames which are reserved for maintenance, and thereafter monitors the processing of the instructions. Due to the multitude of maintenance tasks in these time frames, applications may not access the database at all or only to a limited extent. The maintenance utilities are given priority for accessing the database content. This, however, results in the database not always being fully and completely available, and the applications do not have access to the data at certain times.

The invention is thus based on the technical problem of providing continuous availability to a relational database while simultaneously providing continuous maintenance.

### SUMMARY OF THE INVENTION

The technical problem derived from the aforementioned is solved in accordance with the invention by a method for real time maintenance of database contents, in particular of files of a relational database, in particular DB2, wherein the status of database content is determined using a database-integrated status monitor, wherein status data of the determined statuses is output in real time using said database-integrated status monitor, wherein said output status data is analyzed and compared with comparison data, and wherein maintenance functions are mostly activated directly following a positive compare result.

Using database-integrated monitoring, which in the case of DB2 is realized as real time statistics (RTS), an active monitoring of the status of the data sets is possible with minimum system work load. DB2 RTS externalized these collected status data in adjustable intervals in tables created for this purpose. In accordance with the invention, the intervals are set small so that a real time output of status data statistics is possible. Real time may comprise a period of a few minutes to a few hours. For example, an output is advantageous after 30 minutes or after 1 hour.

Longer or shorter periods are also possible according to the invention. The length of the period depends on the demands placed on the database system with regard to backing up, data reorganization, or collection of data statistics.

The output status data are analyzed in accordance with the invention in real time and the instructions for activating the necessary utilities are created as needed, which depends on the status of the data sets. In order to be able to determine whether maintenance is required, the status data is compared with comparison data. The comparison data can define limiting values which describe a state at which the execution of a tool is considered necessary for a respective data set.

In accordance with the invention, the necessary instruction is immediately created and the maintenance function is activated when a certain comparison value is reached.

Through the real time, database integrated monitoring of the statuses the maintenance necessary is immediately recognized and can be performed in real time. This results in a largely uniform database workload with maintenance tasks and the database content is constantly available for the applications which work with it. It is no longer necessary to define maintenance time frames during which the maintenance utilities work and during which the applications have no access to the data. However, it is also guaranteed that the status of the data always corresponds to the stipulated criteria and thus, for example, errors in the data or long access times can be avoided.

It is often only necessary to run maintenance on data sets when a critical state has been reached. It is thus proposed that the comparison data represent status threshold values of data states. These status threshold values indicate as of when data must be maintained with suitable utilities. Once the determined data set status reaches a certain status threshold value, maintenance can be activated real time using a suitably generated instruction.

Various data sets or groups of data sets are subject to different requirements with regard to their status. Consequently, it is proposed that different threshold values can be set for data sets or groups of data sets. It is also possible that different maintenance functions are indicated for different data statuses so that it is proposed to set different status threshold values for different maintenance functions.

The status of the data changes constantly during operation of the database. The status of the data may gradually deteriorate during operation. It is thus proposed that at least one rigid status threshold value and at least one soft status threshold value is set. Once the soft status threshold value is reached, it is not absolutely necessary to start maintenance of the data using the appropriate utility, but it makes sense to do so. Therefore, starting maintenance may be subject to further criteria, such as, for example, the current system utilization, the size of the data sets, the status of other data or the current time. On the other hand, once the rigid status threshold value has been reached, maintenance of the data can no longer be delayed since massive data errors, long access times, or loss of data is otherwise imminent. In this case, maintenance should be activated immediately and unconditionally.

It is also conceivable that the immediate execution of the maintenance functions are to be suppressed pursuant to application-specific specifications or other requests directed to the database. It is thus proposed that restrictions are determinable at which the immediate activation of the maintenance functions is prevented. In this case, the maintenance function is preferably executed immediately once the restrictions no longer apply.

In accordance with a preferred embodiment, the instructions for activating the maintenance utilities that are generated real time can cause the utilities to be directly executed (by transferring them to JES, Job Entry System). The instructions may also be transferred to a job scheduler. This makes sense when maintenance is to be conducted in accordance with conventional principles. Maintenance is then conducted and monitored by the job scheduler. It is possible, however, when transferring the instructions to the job scheduler, to instruct said scheduler to execute these immediately. Execution is then not triggered by the job scheduler on the basis of its own dependencies, but is monitored by the job scheduler. Finally, it is also possible to transfer the instructions immediately to a database procedure. In the case of the DB2, this is the call for the DB2 Stored Procedure DSNUTILS.

By logging the maintenance functions, maintenance functions that are pending, ongoing, and completed in the past can be monitored. The maintenance status of the database may thus be determinable. Moreover, in the event of an error during maintenance, it is possible to determine which function was faulty and to activate it again or terminate it.

A further aspect of the invention is a device set up to execute a previously described method, with a database unit for the operation of a relational database, wherein said database unit comprises maintenance means for executing maintenance functions, and monitoring means for monitoring and reading out status data about the status of database content stored in said database unit, with a monitoring unit for monitoring said output status data, wherein said monitoring unit comprises means for analyzing status data and for comparing status data with comparison data, and wherein said monitoring unit comprises output means for directly outputting instruction for the activation of said maintenance means for executing a maintenance utility.

The invention also relates to a computer program with an implementation of a previously described method for a computer and also a computer program product with this type of a computer program or with instructions for executing a previously described method.

The invention is described hereinafter in greater detail on the basis of a drawing showing an execution sample.

### BRIEF DESCRIPTION OF THE DRAWING

In the drawing, the sole FIGURE depicts

FIG. 1 a flow chart on an inventive method.

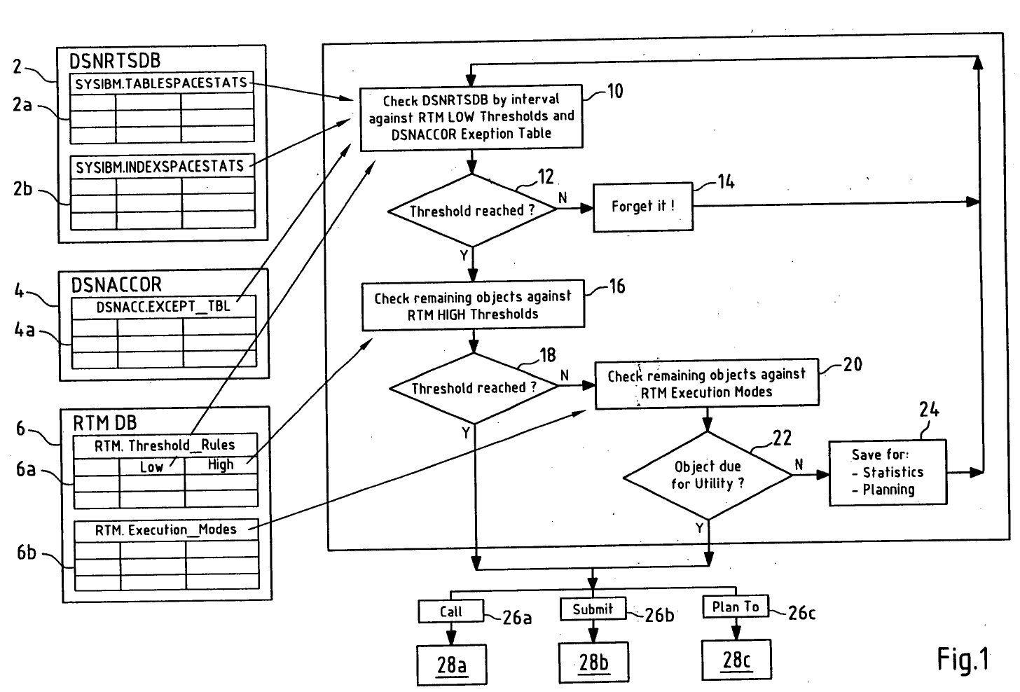

### DETAILED DESCRIPTION OF THE INVENTION

The flow diagram depicts a method in accordance with the invention. In the following the designations and terms within IBM's DB2 are used. The invention, however, can be used for any relational database.

Data sets 2, 4, and 6 are accessed in order to perform the method. Data set 2 (DSNRTSDB) contains the statistics yielded by the real time statistics (RTS) feature integrated in the database system. These statistics are output in determinable time intervals, preferably every half hour. DSNRTSDB 2 contains two tables SYSIBM.TABELSPACESTATS 2a and SYSIBM.INDEXSPACESTATS 2b. These tables 2a and 2b contain the status of the data sets which comprise tables, and the status of the data sets which comprise indexes. The data contained in DSNRTSDB 2 are accessible using SQL queries. The data therein are in particular information about:

the size of the individual data sets;

changes in the data sets since the last COPY;

changes in the data sets since the last REORG;

changes in the data sets since the last RUNSTATS.

The RTS feature integrated in the database uses only a few resources and thus database performance does not suffer due to the constant provision of statistics in the RTS tables.

Data set 4 (DSNACCOR) contains a table 4a (DSNACC.EXCEPT_TBL) that contains application-specific and database-specific exclusions. These exclusions can refer to restrictions with regard to the execution of the maintenance functions. The table DSNACC.EXCEPT_TBL 4a contains both restrictions relating to utilities as well as to certain data sets respectively. These restrictions must be considered when activating maintenance functions and can thus eventually influence the real time triggering of maintenance functions.

Finally, data set 6 (RTM DB) contains two tables, 6a and 6b. Table 6a (RTM.Threshold_Rules) contains comparison values which are used to compare a status of individual data sets with reference statuses. The threshold values in this case are grouped into rigid threshold values and soft threshold values. Once a rigid threshold value is reached, a utility is immediately and unconditionally activated to maintain a data set. In contrast, other conditions can be previously considered in case of a soft threshold value.

The function of the process can be described as follows:

The RTS function is not initialized when it is initially started. Statistical information about information about COPY, REORG, and RUNSTATS will only be recorded and externalized by the RTS function when these utilities have been executed for the respective data set with the RTS function enabled. In this case, a table entry is initialized for this data set by the RTS function and taken into consideration at the next externalization.

For initialization, it is thus possible to determine the status of the individual data sets by using conventional external monitoring functions during operation with RTS enabled. If the external monitoring functions determine a need for executing a utility, the execution of the utility is activated in accordance with conventional methods. Once the maintenance has been applied to the respective data set, the RTS is initialized and changes in status are recorded and updated by the RTS feature The external monitoring functions do not have to monitor this particular data set any longer. External monitoring continues for the remaining data sets until all data sets have been initialized in the RTS. Future decisions regarding data sets and utilities are then made using the methods described below.

First, in Step 10, the statistics of the data sets are read from DSNRTSDB 2. In addition, the threshold values of RTM DB 6 and the restrictions in DSNACCOR 4 are determined.

In Step 12, the statistics is compared with the soft threshold values of RTM DB 4. Once a status of a data set has reached this threshold value, the maintenance action to be conducted is determined. This is followed by a check whether the maintenance of the data sets with the selected maintenance function stands in contrast to a restriction in the data set DSNACCOR 4.

In the event the threshold value is not reached or a restriction exists, monitoring of the data set statistics is reactivated in Step 14.

In Step 16, the rigid threshold values are determined from RTM DB 6.

In Step 18, it is checked whether a rigid threshold value has been reached by the determined status of the respective data set. If this is the case, activation 26b of the necessary maintenance function may be executed immediately.

Subsequently, in Step 20, further adjustable restrictions are determined from RTM.Execution_Modes 6b.

In Step 22, it is decided whether maintenance of the respective data set with the intended utility conflicts with a restriction. If this is the case, the monitoring of the statuses is activated again in Step 24 and the determined data is stored for further planning and statistics.

If there are no further restrictions, the utilities are executed 26 using one of three execution options 26a, 26b, or 26c. This means that batch instructions are produced for maintenance utilities which are subject to utility JCL in which the information about the status of the data sets to be maintained is used. The generated instruction is executed in Step 26a by calling the DB2 Stored Procedure DSNUTILS 28a. In Step 26b, the instruction is executed immediately by transferring it to JES 28b and in Step 26c the utility is transferred dynamically to the job scheduler 28c. Which execution option 26 is chosen is adjustable. The immediate execution of the utility should be guaranteed, however, for each of the three options. Furthermore, the execution of the utilities may be logged and a log file may be fed with logging entries.

Through the continuous monitoring and maintenance of the data sets, as proposed in accordance with the invention, the maintenance status of the data set of a database can be optimized without reducing system performance of the database essentially. In particular, by utilizing the status monitoring that is integrated in the database (RTS), the status of the data sets can be monitored with little effort and maintained as needed.

Although the description above contains many specifics, these should not be construed as limiting the scope of the invention but as merely providing illustrations of some of the presently preferred embodiments of this invention. Thus, the scope of the invention should be determined by the appended claims and their legal equivalents rather than by the examples given.

1. A method for real time maintenance of database contents, in particular of files of a relational database, in particular DB2,
wherein the status of database content is determined using a database-integrated status monitor,
wherein status data of the determined statuses is output in real time using said database-integrated status monitor,
wherein said output status data is analyzed and compared with comparison data, and
wherein maintenance functions are mostly activated directly following a positive compare result.

2. The method of claim 1, characterized in that the comparison of status data with status threshold values is conducted, wherein said status threshold values represent data statuses indicating an execution of the maintenance functions for the respective database contents.

3. The method of claim 2, characterized in that said status threshold values for different database content and/or groups of database content and/or different maintenance functions are adjusted respectively.

4. The method of claim 2, characterized in that at least one rigid status threshold value is set, that at least one soft status threshold value is set, that the maintenance function is activated when the soft status threshold value is reached and further criteria apply, and that the maintenance function is activated immediately when the rigid status threshold value is reached.

5. The method of claim 1, characterized in that restrictions related to the system, time, data and/or application are defined for the execution of maintenance functions in which an immediate execution of a maintenance function is suppressed at least temporarily.

6. The method of claim 1, characterized in that the real time activation of the maintenance functions causes direct execution, its transfer to a job scheduler, or a call of database utilities.

7. The method of claim 1, characterized in that the executed maintenance functions are logged and a maintenance log is produced.

8. A device, set up to execute a method according to claim 1,
with a database unit for the operation of a relational database,
wherein said database unit comprises maintenance means for executing maintenance functions, and
monitoring means for monitoring and reading out status data about the status of database content stored in said database unit,
with a monitoring unit for monitoring said output status data,
wherein said monitoring unit comprises means for analyzing status data and for comparing status data with comparison data, and
wherein said monitoring unit comprises output means for directly outputting instruction for the activation of said maintenance means for executing a maintenance utility.

9. A computer program with an implementation of a method of claim 1 for a computer.

10. A computer program product with a computer program of claim 9 or with instructions for executing a method of claim 1.
